(19) United States
(12) Patent Application Publication
(10) Pub. No.: US 2023/0401092 A1
(43) Pub. Date: Dec. 14, 2023

(54) RUNTIME TASK SCHEDULING USING IMITATION LEARNING FOR HETEROGENEOUS MANY-CORE SYSTEMS

(71) Applicants: Arizona Board of Regents on Behalf of Arizona State University, Scottsdale, AZ (US); Arizona Board of Regents on Behalf of the University of Arizona, Tucson, AZ (US); Board of Regents, The University of Texas System, Austin, TX (US); Carnegie Mellon University, Pittsburgh, PA (US)

(72) Inventors: Umit Ogras, Tempe, AZ (US); Radu Marculescu, Austin, TX (US); Ali Akoglu, Tucson, AZ (US); Chaitali Chakrabarti, Tempe, AZ (US); Daniel Bliss, Phoenix, AZ (US); Samet Egemen Arda, Chandler, AZ (US); Anderson Sartor, La Jolla, CA (US); Nirmal Kumbhare, Tucson, AZ (US); Anish Krishnakumar, Madison, WI (US); Joshua Mack, Tucson, AZ (US); Ahmet Goksoy, Madison, WI (US); Sumit Mandal, Madison, WI (US)

(21) Appl. No.: 18/249,851

(22) PCT Filed: Oct. 22, 2021
(86) PCT No.: PCT/US2021/056258

§ 371 Date: Apr. 20, 2023

Related U.S. Application Data
(60) Provisional application No. 63/104,260, filed on Oct. 22, 2020.

(51) Int. Cl. G06F 9/48; G06F 15/80

(52) U.S. Cl. CPC G06F 9/4881; G06F 15/80

(57) ABSTRACT

Runtime task scheduling using imitation learning (IL) for heterogenous many-core systems is provided. Domain-specific systems-on-chip (DSSoCs) are recognized as a key approach to narrow down the performance and energy-efficiency gap between custom hardware accelerators and programmable processors. Reaching the full potential of these architectures depends critically on optimally scheduling the applications to available resources at runtime. Existing optimization-based techniques cannot achieve this objective at runtime due to the combinatorial nature of the task scheduling problem. In an exemplary aspect described herein, scheduling is posed as a classification problem, and embodiments propose a hierarchical IL-based scheduler that learns from an Oracle to maximize the performance of multiple domain-specific applications. Extensive evaluations show that the proposed IL-based scheduler approximates an offline Oracle policy with more than 99% accuracy for performance- and energy-based optimization objectives. Furthermore, it achieves almost identical performance to the Oracle with a low runtime overhead and high adaptivity.

### RELATED APPLICATIONS

This application claims the benefit of provisional patent application Ser. No. 63/104,260, filed Oct. 22, 2020, the disclosure of which is hereby incorporated herein by reference in its entirety.

### GOVERNMENT SUPPORT

This invention was made with government support under FA8650-18-2-7860 awarded by the Defense Advanced Research Projects Agency. The government has certain rights in the invention.

### FIELD OF THE DISCLOSURE

The present disclosure relates to application task scheduling in computing systems.

### BACKGROUND

Homogeneous multi-core architectures have successfully exploited thread- and data-level parallelism to achieve performance and energy efficiency beyond the limits of single-core processors. While general-purpose computing achieves programming flexibility, it suffers from significant performance and energy efficiency gap when compared to special-purpose solutions. Domain-specific architectures, such as graphics processing units (GPUs) and neural network processors, are recognized as some of the most promising solutions to reduce this gap. Domain-specific systems-on-chip (DSSoCs), a concrete instance of this new architecture, judiciously combine general-purpose cores, special-purpose processors, and hardware accelerators. DSSoCs approach the efficacy of fixed-function solutions for a specific domain while maintaining programming flexibility for other domains.

The success of DSSoCs depends critically on satisfying two intertwined requirements. First, the available processing elements (PEs) must be utilized optimally, at runtime, to execute the incoming application tasks. For instance, scheduling all tasks to general-purpose cores may work, but diminishes the benefits of the special-purpose PEs. Likewise, a static task-to-PE mapping could unnecessarily stall the parallel instances of the same task. Second, acceleration of the domain-specific applications needs to be oblivious to the application developers to make DSSoCs practical.

The task scheduling problem involves assigning tasks to PEs and ordering their execution to achieve the optimization goals, e.g., minimizing execution time, power dissipation, or energy consumption. To this end, applications are abstracted using mathematical models, such as directed acyclic graph (DAG) and synchronous data graphs (SDG) that capture both the attributes of individual tasks (e.g., expected execution time) and the dependencies among the tasks. Scheduling these tasks to the available PEs is a well-known NP-complete problem. An optimal static schedule can be found for small problem sizes using optimization techniques, such as mixed-integer programming (MIP) and constraint programming (CP). These approaches are not applicable to runtime scheduling for two fundamental reasons. First, statically computed schedules lose relevance in a dynamic environment where tasks from multiple applications stream in parallel, and PE utilizations change dynamically. Second, the execution time of these algorithms, hence their overhead, can be prohibitive even for small problem sizes with few tens of tasks. Therefore, a variety of heuristic schedulers, such as shortest job first (SJF) and complete fair schedulers (CFS), are used in practice for homogeneous systems. These algorithms trade off the quality of scheduling decisions and computational overhead.

### SUMMARY

Runtime task scheduling using imitation learning (IL) for heterogenous many-core systems is provided. Domain-specific systems-on-chip (DSSoCs), a class of heterogeneous many-core systems, are recognized as a key approach to narrow down the performance and energy-efficiency gap between custom hardware accelerators and programmable processors. Reaching the full potential of these architectures depends critically on optimally scheduling applications to available resources at runtime. Existing optimization-based techniques cannot achieve this objective at runtime due to the combinatorial nature of the task scheduling problem. In an exemplary aspect described herein, scheduling is posed as a classification problem, and embodiments propose a hierarchical IL-based scheduler that learns from an oracle to maximize the performance of multiple domain-specific applications. Extensive evaluations with six streaming applications from wireless communications and radar domains show that the proposed IL-based scheduler approximates an offline oracle policy with more than 99% accuracy for performance- and energy-based optimization objectives. Furthermore, it achieves almost identical performance to the oracle with a low runtime overhead and successfully adapts to new applications, many-core system configurations, and runtime variations in application characteristics.

An exemplary embodiment provides a method for runtime task scheduling in a heterogeneous multi-core computing system. The method includes obtaining an application comprising a plurality of tasks, obtaining IL policies for task scheduling, and scheduling the plurality of tasks on a heterogeneous set of processing elements according to the IL policies.

Another exemplary embodiment provides an application scheduling framework. The application scheduling framework includes a heterogeneous system-on-chip (SoC) simulator configured to simulate a plurality of scheduling algorithms for a plurality of application tasks. The application scheduling framework further includes an oracle configured to predict actions for task scheduling during runtime and an IL policy generator configured to generate IL policies for task scheduling during runtime on a heterogeneous SoC, wherein the IL policies are trained using the oracle and the SoC simulator.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1A is a schematic diagram of an exemplary directed acyclic graph (DAG) for modeling a streaming application with seven application tasks.

FIG. 1B is a sample schedule of the DAG of FIG. 1A on an exemplary heterogeneous many-core system.

FIG. 2 is a schematic diagram of an exemplary imitation learning (IL) framework for task scheduling in a heterogeneous many-core system.

FIG. 3 is a schematic diagram of an exemplary configuration of another heterogeneous many-core platform used for scheduler evaluations.

FIG. 4 is a graphical representation comparing average runtime per scheduling decision for various applications with a constraint programming (CP) solver with a one minute time-out (CP₁₋ₘᵢₙ), a CP solver with a five minute time-out (CP₅₋ₘᵢₙ), and an earliest task first (ETF) scheduler.

FIG. 5 is a graphical representation comparing average execution time of the applications for various applications with oracle, IL (proposed), and IL policies with subsets of features.

FIG. 6 is a graphical representation comparing average job execution time between oracle, CP solutions, and IL policies to schedule a workload comprising a mix of six streaming applications.

FIG. 7 is a graphical representation comparing average slowdown of a baseline IL leave-one-out (IL-LOO) and proposed policy with DAgger leave-one-out (IL-LOO-DAgger) iterations with respect to the oracle.

FIG. 8A is a graphical representation of average job execution times for the oracle, baseline-IL, as well as IL-LOO and IL-LOO-DAgger iterations with a WiFi transmitter (WiFi-TX) application left out.

FIG. 8B is a graphical representation of average job execution times for the oracle, baseline-IL, as well as IL-LOO and IL-LOO-DAgger iterations with a WiFi receiver (WiFi-RX) application left out.

FIG. 8C is a graphical representation of average job execution times for the oracle, baseline-IL, as well as IL-LOO and IL-LOO-DAgger iterations with a range detection (RangeDet) application left out.

FIG. 8D is a graphical representation of average job execution times for the oracle, baseline-IL, as well as IL-LOO and IL-LOO-DAgger iterations with a single-carrier transmitter (SC-TX) application left out.

FIG. 8E is a graphical representation of average job execution times for the oracle, baseline-IL, as well as IL-LOO and IL-LOO-DAgger iterations with a single-carrier receiver (SC-RX) application left out.

FIG. 8F is a graphical representation of average job execution times for the oracle, baseline-IL, as well as IL-LOO and IL-LOO-DAgger iterations with a temporal mitigation (TempMit) application left out.

FIG. 9 is a graphical representation of an IL policy evaluation with various many-core platform configurations.

FIG. 10 is a graphical representation comparing average slowdown for each of 50 different workloads (represented as W-1, W-2, and so on) normalized to IL-DAgger policies against the oracle.

FIG. 11A is a graphical representation of average execution time of the workload with oracles and IL policies for performance, energy-delay product (EDP), and energy-delay² product (ED²P) objectives.

FIG. 11B is a graphical representation of average energy consumption of the workload with oracles and IL policies for performance, EDP, and ED²P objectives.

FIG. 12 is a graphical representation comparing average execution time between oracle, IL, and reinforcement learning (RL) policies to schedule a workload comprising a mix of six streaming real-world applications.

FIG. 13 is a block diagram of a computer system 1300 suitable for implementing runtime task scheduling with IL according to embodiments disclosed herein.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Runtime task scheduling using imitation learning (IL) for heterogenous many-core systems is provided. Domain-specific systems-on-chip (DSSoCs), a class of heterogeneous many-core systems, are recognized as a key approach to narrow down the performance and energy-efficiency gap between custom hardware accelerators and programmable processors. Reaching the full potential of these architectures depends critically on optimally scheduling applications to available resources at runtime. Existing optimization-based techniques cannot achieve this objective at runtime due to the combinatorial nature of the task scheduling problem. In an exemplary aspect described herein, scheduling is posed as a classification problem, and embodiments propose a hierarchical IL-based scheduler that learns from an oracle to maximize the performance of multiple domain-specific applications. Extensive evaluations with six streaming applications from wireless communications and radar domains show that the proposed IL-based scheduler approximates an offline oracle policy with more than 99% accuracy for performance- and energy-based optimization objectives. Furthermore, it achieves almost identical performance to the oracle with a low runtime overhead and successfully adapts to new applications, many-core system configurations, and runtime variations in application characteristics.

I. Introduction

The present disclosure addresses the following challenging proposition: Can a scheduler performance be achieved that is close to that of optimal mixed-integer programming (MIP) and constraint programming (CP) schedulers while using minimal runtime overhead compared to commonly used heuristics? Furthermore, this problem is investigated in the context of heterogeneous processing elements (PEs). Much of the scheduling in heterogeneous many-core systems is tuned manually, even to date. For example, OpenCL, a widely-used programming model for heterogeneous cores, leaves the scheduling problem to the programmers. Experts manually optimize the task-to-resource mapping based on their knowledge of application(s), characteristics of the heterogeneous clusters, data transfer costs, and platform architecture. However, manual optimization suffers from scalability for two reasons. First, optimizations do not scale well for all applications. Second, extensive engineering efforts are required to adapt the solutions to different platform architectures and varying levels of concurrency in applications. Hence, there is a critical need for a methodology to provide optimized scheduling solutions applicable to a variety of applications at runtime in heterogeneous many-core systems.

Scheduling has traditionally been considered as an optimization problem. In an exemplary aspect, the present disclosure changes this perspective by formulating runtime scheduling for heterogeneous many-core platforms as a classification problem. This perspective and the following key insights enable employment of machine learning (ML) techniques to solve this problem:
Key insight 1: One can use an optimal (or near-optimal) scheduling algorithm offline without being limited by computational time and other runtime overheads. Then, the inputs to this scheduler and its decisions can be recorded along with relevant features to construct an oracle.
Key insight 2: One can design a policy that approximates the oracle with minimum overhead and use this policy at runtime.
Key insight 3: One can exploit the effectiveness of ML to learn from oracle with different objectives, which includes minimizing execution time, energy consumption, etc.

Realizing this vision requires addressing several challenges. First, an oracle needs to be constructed in a dynamic environment where tasks from multiple applications can overlap arbitrarily, and each incoming application instance observes a different system state. Finding optimal schedules is challenging even offline, since the underlying problem is NP-complete. This challenge is addressed by constructing oracles using both CP and a computationally expensive heuristic, called earliest task first (ETF). ML uses informative properties of the system (features) to predict the category in a classification problem.

The second challenge is identifying the minimal set of relevant features that can lead to high accuracy with minimal overhead. A small set of 45 relevant features are stored for a many-core platform with sixteen PEs along with the oracle to minimize the runtime overhead. This enables embodiments to represent a complex scheduling decision as a set of features and then predict the best PE for task execution.

The final challenge is approximating the oracle accurately with a minimum implementation overhead. Since runtime task scheduling is a sequential decision-making problem, supervised learning methodologies, such as linear regression and regression tree, may not generalize for unseen states at runtime. Reinforcement learning (RL) and imitation learning (IL) are more effective for sequential decision-making problems. Indeed, RL has shown promise when applied to the scheduling problem, but it suffers from slow convergence and sensitivity of the reward function. In contrast, IL takes advantage of the expert's inherent knowledge and produces policies that imitate the expert decisions.

An IL-based framework is proposed that schedules incoming applications to heterogeneous multi-core systems. The proposed IL framework is formulated to facilitate generalization, i.e., it can be adapted to learn from any oracle that optimizes a specific objective, such as performance and energy efficiency, of an arbitrary heterogeneous system-on-chip (SoC) (e.g., a DSSoC). The proposed framework is evaluated with six domain-specific applications from wireless communications and radar systems. The proposed IL policies successfully approximate the oracle with more than 99% accuracy, achieving fast convergence and generalizing to unseen applications. In addition, the scheduling decisions are made within 1.1 microsecond (μs) (on an Arm A53 core), which is better than CFS performance (1.2 μs). This is the first IL-based scheduling framework for heterogeneous many-core systems capable of handling multiple applications exhibiting streaming behavior. The main contributions of this disclosure are as follows:
An imitation learning framework to construct policies for task scheduling in heterogeneous many-core platforms.
Oracle design using both optimal and heuristic schedulers for performance- and energy-based optimization objectives.
Extensive evaluation of the proposed IL policies along with latency and storage overhead analysis.
Performance comparison of IL policies against reinforcement learning and optimal schedules obtained by constraint programming.

Section II provides an overview of directed acrylic graph (DAG) scheduling and imitation learning. Section III presents the proposed methodology, followed by relevant evaluation results in Section IV. Section V presents a computer system which may be used in embodiments described herein.

II. Overview of Runtime Scheduling Problem

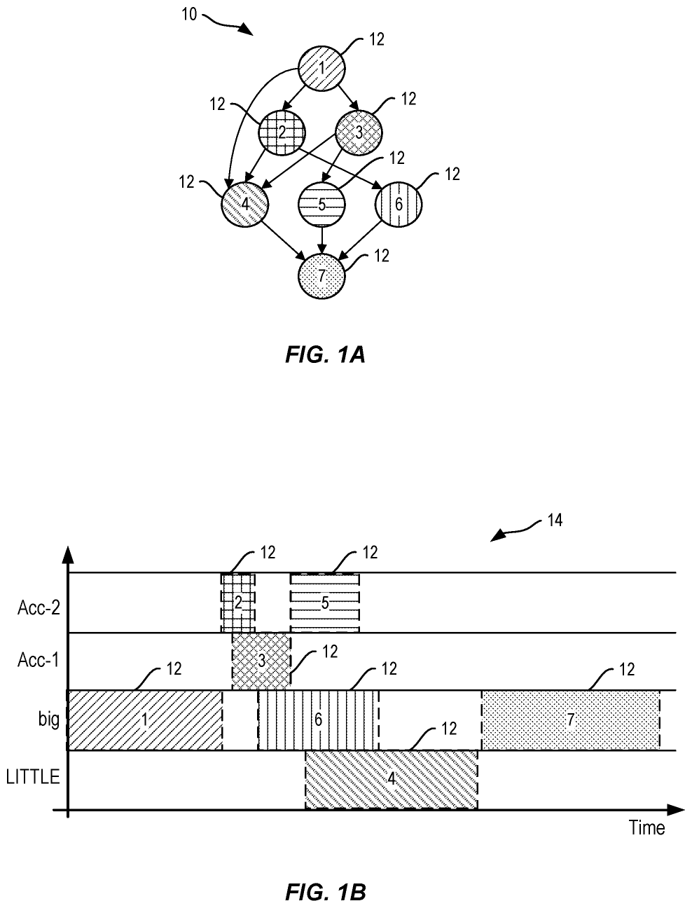

FIGS. 1A and 1B illustrate the runtime scheduling problem addressed herein. FIG. 1A is a schematic diagram of an exemplary DAG for modeling a streaming application 10 with seven application tasks 12. FIG. 1B is a sample schedule of the DAG 10 of FIG. 1A on an exemplary heterogeneous many-core system 14 (e.g., a heterogenous SoC, such as a DSSoC).

Streaming applications 10 are considered that can be modeled using DAGs, such as the one shown in FIG. 1A. These applications 10 process data frames that arrive at a varying rate over time. For example, a WiFi-transmitter (WiFi-TX), one of the domain applications 10, receives and encodes raw data frames before they are transmitted over the air. Data frames from a single application 10 or multiple simultaneous applications 10 can overlap in time as they go through the tasks 12 that compose the application 10. For instance, Task-1 in FIG. 1A can start processing a new frame, while other tasks 12 continue processing earlier frames. Processing of a frame is said to be completed after the terminal task 12 without any successor (Task-7 in FIG. 1A) is executed. The application 10 is defined formally to facilitate description of the schedulers.

Definition 1: An application graph G_{App} ( [symbol] , ε) is a DAG, where each node Tᵢ∈ [symbol] represents the tasks 12 that compose the application 10. Directed edge eᵢⱼ∈ε from task Tᵢ to Tⱼ shows that Tⱼ cannot start processing a new frame before the output of Tᵢ reaches Tⱼ for all Tᵢ, Tⱼε [symbol] . vᵢⱼ for each edge eᵢⱼ∈ε denotes the communication volume over this edge. It is used to account for the communication latency.

Each task 12 in a given application graph G_{App} can execute on different PEs in the target SoC. The target SoCs are formally defined as follows:

Definition 2: An architecture graph G_{Arch}( [symbol] , [symbol] ) is a directed graph, where each node Pᵢ∈ [symbol] represents PEs, and Lᵢⱼ∈ [symbol] represents the communication links between Pᵢ and Pⱼ in the target SoC. The nodes and links have the following quantities associated with them:
tₑₓₑ(Pᵢ, Tⱼ) is the execution time of task Tⱼ on PE Pᵢ∈ [symbol] , if Pᵢ can execute (i.e., it supports) Tⱼ.
t_{comm}(Lᵢⱼ) is the communication latency from Pᵢ to Pⱼ for all Pᵢ, Pᵢ∈ [symbol] .
C(Pᵢ)∈C is the PE cluster Pᵢ∈ [symbol] belongs to.

The heterogeneous many-core system 14 illustrated in FIG. 1B can be a DSSoC, such as described in Table I, which assumes one big core cluster, one LITTLE core cluster, and two hardware accelerators each with a single PE in them for simplicity. The low-power (LITTLE) and high-performance (big) general-purpose clusters can support the execution of all tasks 12, as shown in the supported tasks column in Table I. In contrast, hardware accelerators (Acc-1 and Acc-2) support only a subset of tasks 12.

TABLE I
DSSoC PEs and Supported Tasks

| Clusters and PEs | Supported Tasks |
|---|---|
| High-performance (big) general-purpose | 1, 2, 3, 4, 5, 6, 7 |
| Low-power (LITTLE) general-purpose | 1, 2, 3, 4, 5, 6, 7 |
| Hardware accelerator-1 (Acc-1) | 3, 5 |
| Hardware accelerator-2 (Acc-2) | 2, 5, 6 |

A particular instance of the scheduling problem is illustrated in FIG. 1B. Task-6 is scheduled to big core (although it executes faster on Acc-2) since Acc-2 is not available at the time of decision making. Similarly, Task-4 is scheduled to the LITTLE core (even if it executes faster on big) because the big core is utilized when Task-4 is ready to execute. In general, scheduling complex DAGs in heterogeneous many-core platforms present a multitude of choices making the runtime scheduling problem highly complex. The complexity increases further with: (1) overlapping DAGs at runtime, (2) executing multiple applications 10 simultaneously, and (3) optimizing for objectives such as performance, energy, etc.

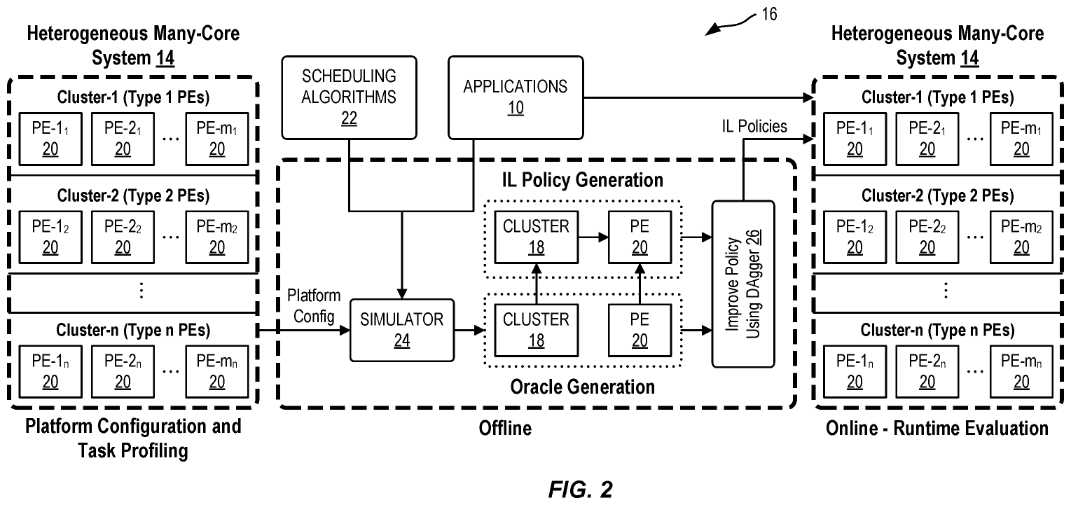

FIG. 2 is a schematic diagram of an exemplary IL framework 16 for task 12 scheduling in a heterogeneous many-core system 14. Embodiments described herein leverage IL, as outlined in FIG. 2. IL is also referred to as learning by demonstration and is an adaption of supervised learning for sequential decision-making problems. The decision-making space is segmented into distinct decision epochs, called states ( [symbol] ). There exists a finite set of actions [symbol] for every state s∈ [symbol] . IL uses policies that map each state (s) to a corresponding action.

Definition 3: Oracle Policy (expert) π*(s): [symbol] → [symbol] maps a given system state to the optimal action. In the runtime scheduling problem, the state includes the set of ready tasks 12 and actions that correspond to assignment of tasks [symbol] to PEs [symbol] . Given the oracle π*, the goal with imitation learning is to learn a runtime policy that can approximate it. An oracle is constructed offline and approximates the runtime policy using a hierarchical policy with two levels. Consider a generic heterogeneous many-core system 14 (e.g., a heterogeneous SoC) with a set of processing clusters [symbol] , as illustrated in FIG. 2. At the first level, an IL policy chooses one processing cluster 18 (among n clusters) for execution of an application task 12.

The first-level policy assigns the ready tasks 12 to one of the processing clusters 18 in [symbol] , since each PE 20 within the same processing cluster 18 has the same static parameters. Then, a cluster-level policy assigns the tasks 12 to a specific PE 20 within that processing cluster 18. The details of state representation, oracle generation, and hierarchical policy design are presented in the next section.

III. Proposed Methodology and Approach

This section first introduces the system state representation, including the features used by the IL policies. Then, it presents the oracle generation process, and the design of the hierarchical IL policies. Table II details the notations that will be used hereafter.

TABLE II
Summary of the Notations Used Herein.

| | | | |
|---|---|---|---|
| Tⱼ | Task-j | [symbol] | Set of Tasks |
| Pᵢ | PE-i | [symbol] | Set of PEs |
| c | Cluster-c | [symbol] | Set of clusters |
| Lᵢⱼ | Communication links | [symbol] | Set of |
| | between Pᵢ to Pⱼ | | communication links |
| tₑₓₑ(Pᵢ,Tⱼ) | Execution time of | t_{comm}(Lᵢⱼ) | Communication |
| | task Tⱼ on PE to Pᵢ | | latency from Pᵢ, to Pⱼ |
| s | State-s | S | Set of states |
| uⱼₖ | Communication volume | [symbol] | Set of actions |
| | from task Tⱼ to Tₖ | | |
| [symbol] _{S} | Static features | [symbol] _{D} | Dynamic features |
| π_{c}(s) | Apply cluster policy | π_{P,c}(s) | Apply PE policy |
| | for state s | | in cluster-c for state s |
| π | Policy | π* | Oracle policy |
| π^{G} | Policy for many-core | π*^{G} | Oracle for many-core |
| | platform configuration G | | platform configuration G |

A. System State Representation

Offline scheduling algorithms are NP-complete even though they rely on static features, such as average execution times. The complexity of runtime decisions is further exacerbated as the system schedules multiple applications 10 that exhibit streaming behavior. In the streaming scenario, incoming frames do not observe an empty system with idle processors. In strong contrast, PEs 20 have different utilization, and there may be an arbitrary number of partially processed frames in the wait queues of the PEs 20. Since one goal is to learn a set of policies that generalize to all applications 10 and all streaming intensities, the ability to learn the scheduling decisions critically depends on the effectiveness of state representation. The system state should encompass both static and dynamic aspects of the set of tasks 12, applications 10, and the target platform. Naive representations of DAGs include adjacency matrix and adjacency list. However, these representations suffer from drawbacks such as large storage requirements, highly sparse matrices which complicates the training of supervised learning techniques, and scalability for multiple streaming applications 10. In contrast, the factors that influence task 12 scheduling are carefully studied in a streaming scenario and construct features that accurately represent the system state. The features that make up the state are broadly categorized as follows:

Task features: This set includes the attributes of individual tasks 12. They can be both static, such as average execution time of a task 12 on a given PE 20 (tₑₓₑ(Pᵢ, Tⱼ)), and dynamic, such as the relative order of a task 12 in the queue.

Application features: This set describes the characteristics of the entire application 10. They are static features, such as the number of tasks 12 in the application 10 and the precedence constraints between them.

PE features: This set describes the dynamic state of the PEs 20. Examples include the earliest available times (readiness) of the PEs 20 to execute tasks 12.

The static features are determined at the design time, whereas the dynamic features can only be computed at runtime. The static features aid in exploiting design time behavior. For example, tₑₓₑ(Pᵢ; Tⱼ) helps the scheduler compare the expected performance of different PEs 20. Dynamic features, on the other hand, present the runtime dependencies between tasks 12 and jobs and the busy states of the PEs 20. For example, the expected time when cluster c becomes available for processing adds invaluable information, which is only available at runtime.

In summary, the features of a task 12 comprehensively represent the task 12 itself and the state of the PEs 20 in the system to effectively learn the decisions from the oracle policy. The specific types of features used in this work to represent the state and their categories are listed in Table III. The static and dynamic features are denoted as [symbol] _{S} and [symbol] _{D}, respectively. Then, the system state is defined at a given time instant k using the features in Table III as:

sₖ= [symbol] _{S,k}∪ [symbol] _{D,k} Equation 1

where [symbol] _{S,k} and [symbol] _{D,k} denote the static and dynamic features respectively at a given time instant k. For an SoC 18 with sixteen PEs 20 grouped as five processing clusters 18, a set of 45 features for the proposed IL technique are obtained.

TABLE III
Types of Features Employed for State Representation from Point of
View of Task Tⱼ

| Feature Type | Feature Description | Feature Categories |
|---|---|---|
| Static | ID of task-j in the DAG | Task |
| ( [symbol] _{S}) | Execution time of a task Tⱼ | Task |
| | in PE Pᵢ (tₑₓₑ(Pᵢ,Tⱼ)) | PE |
| | Downward depth of task Tⱼ | Task |
| | in the DAG | Application |
| | IDs of predecessor tasks | Task |
| | of task Tⱼ | Application |
| | Application ID | Application |
| | Power consumption of task Tⱼ | Task |
| | in PE Pᵢ | PE |
| Dynamic | Relative order of task Tⱼ in | Task |
| ( [symbol] _{D}) | the ready queue | |
| | Earliest time when PEs | PE |
| | in a cluster-c are ready | |
| | for task execution | |
| | Clusters in which predecessor | Task |
| | tasks of task Tⱼ, executed | |
| | Communication volume from task | Task |
| | Tⱼ, to task Tₖ(vⱼₖ) | |

B. Oracle Generation

The goal of this work is to develop generalized scheduling models for streaming applications 10 of multiple types to be executed on heterogeneous many-core systems 14. The generality of the IL-based scheduling framework 16 enables using IL with any oracle. The oracle can be or use any scheduling algorithm 22 that optimizes an arbitrary metric, such as execution time, power consumption, and total SoC 18 energy.

To generate the training dataset, both optimal scheduling algorithms 22 are implemented using CP and heuristics. These scheduling algorithms 22 are integrated into a SoC simulator 24, as explained under evaluation results. Suppose a new task Tⱼ becomes ready at time k. The oracle is called to schedule the task 12 to a PE 20. The oracle policy for this action task 12 with system state sₖ can be expressed as:

π*(sₖ)=Pᵢ Equation 2

where Pᵢ∈ [symbol] is the PE Tⱼ scheduled to and sₖ is the system state defined in Equation 1. After each scheduling action, the particular task 12 that is scheduled (Tⱼ), the system state sₖ∈ [symbol] , and the scheduling decision are added to the training data. To enable the oracle policies to generalize for different workload conditions, workload mixes are constructed using the target applications 10 at different data rates, as detailed in Section IV-A.

C. IL-Based Scheduling Framework

This section presents the hierarchical IL-based scheduler for runtime task scheduling in heterogeneous many-core platforms. A hierarchical structure is more scalable since it breaks a complex scheduling problem down into simpler problems. Furthermore, it achieves a significantly higher classification accuracy compared to a flat classifier (>93% versus 55%), as detailed in Section IV-D.

Algorithm 1: Hierarchical imitation learning Framework

| | |
|---|---|
| 1 | for task T ∈ [symbol] do |
| 2 | \| s = Get current state for task T |
| | \| /* Level-1 IL policy to assign cluster */ |
| 3 | \| c = π_{C}(s) |
| | \| /* Level-2 IL policy to assign PE */ |
| 4 | \| p = π_{P, c}(s) |
| | \| /* Assign T to the predicted PE */ |
| 5 | end |

Algorithm 2: Methodology to aggregate data in
a hierarchical imitation learning framework

| 1 | for task T ∈ [symbol] do | | |
|---|---|---|---|
| 2 | \| | s = Get current state for task T | |
| 3 | \| | if π_{C}(s) == π_{C}*(s) then | |
| 4 | \| | \| | if π_{P, c}(s) != π_{P, c}*(s) then |
| 5 | \| | \| | \| Aggregate state s and label π_{P, c}*(s) to the dataset |
| 6 | \| | \| | end |
| 7 | \| | end | |
| 8 | \| | else | |
| 9 | \| | \| | Aggregate state s and label π_{C}*(s) to the dataset |
| 10 | \| | \| | c* = π_{C}*(s) |
| 11 | \| | \| | if π_{P, c}*(s) != π_{P, c}**(s) then |
| 12 | \| | \| | \| Aggregate state s and label π_{P, c}*(s) to the dataset |
| 13 | \| | \| | end |

| | | |
|---|---|---|
| 14 | \| | end |
| | \| | /* Assign T to the predicted PE */ |

| | |
|---|---|
| 15 | end |

The hierarchical IL-based scheduler policies approximate the oracle with two levels, as outlined in Algorithm 1. The first level policy π_{c}(s): [symbol] → [symbol] is a coarse-grained scheduler that assigns tasks 12 into processing clusters 18. This is a natural choice since individual PEs 20 within a processing cluster 18 have identical static parameters, i.e., they differ only in terms of their dynamic states. The second level (i.e., fine-grained scheduling) consists of one dedicated policy π_{P,c}(s): [symbol] → [symbol] for each cluster c∈ [symbol] . These policies assign the input task 12 to a PE 20 within its own processing cluster 18, i.e., π_{P,c}(s)∈ [symbol] , ∀_{c}∈ [symbol] . Off-the-shelf machine learning techniques, such as regression trees and neural networks, are leveraged to construct the IL policies. The application of these policies approximates the corresponding oracle policies constructed offline.

IL policies suffer from error propagation as the state-action pairs in the oracle are not necessarily independent and identically distributed (i.i.d). Specifically, if the decision taken by the IL policies at a particular decision epoch is different from the oracle, then the resultant state for the next epoch is also different with respect to the oracle. Therefore, the error further accumulates at each decision epoch. This can occur during runtime task scheduling when the policies are applied to applications 10 that the policies did not train with. This problem is addressed by a data aggregation algorithm (DAgger) 26, proposed to improve IL policies. DAgger 26 adds the system state and the oracle decision to the training data whenever the IL policy makes a wrong decision. Then, the policies are retrained after the execution of the workload.

DAgger 26 is not readily applicable to the runtime scheduling problem since the number of states is unbounded as a scheduling decision at time t for state s(sₜ) can result in any possible resultant state, sₜ₊₁. In other words, the feature space is continuous, and hence, it is infeasible to generate an exhaustive oracle offline. This challenge is overcome by generating an oracle on-the-fly. More specifically, the proposed framework is incorporated into a simulator 24. The offline scheduler used as the oracle is called dynamically for each new task 12. Then, the training data is augmented with all the features, oracle actions, as well as the results of the IL policy under construction. Hence, the data aggregation process is performed as part of the dynamic simulation.

The hierarchical nature of the proposed IL framework 16 introduces one more complexity to data aggregation. The cluster policy's output may be correct, while the PE cluster reaches a wrong decision (or vice versa). If the cluster prediction is correct, this prediction is used to select the PE policy of that cluster, as outlined in Algorithm 2. Then, if the PE prediction is also correct, the execution continues; otherwise, the PE data is aggregated in the dataset. However, if the cluster prediction does not align with the oracle, in addition to aggregating the cluster data, an on-the-fly oracle is invoked to select the PE policy, then the PE prediction is compared to the oracle, and the PE data is aggregated in case of a wrong prediction.

IV. Evaluation Results

Section IV-A presents the evaluation methodology and setup. Section IV-B explores different machine learning classifiers for IL. The significance of the proposed features is studied using a regression tree classifier in Section IV-C. Section IV-D presents the evaluation of the proposed IL scheduler. Section IV-E analyzes the generalization capabilities of IL-scheduler. The performance analysis with multiple workloads is presented in Section IV-F. The evaluation of the proposed IL technique to energy-based optimization objectives is demonstrated in Section IV-G. Section V-H presents comparisons with an RL-based scheduler and Section IV-I analyzes the complexity of the proposed approach.

A. Evaluation Methodology and Setup

Domain Applications: The proposed IL scheduling methodology is evaluated using applications from wireless communication and radar processing domains. WiFi-TX, WiFi-receiver (WiFi-RX), range detection (RangeDet), single-carrier transmitter (SC-TX), single-carrier receiver (SC-RX) and temporal mitigation (TempMit) applications are employed, as summarized in Table IV. Workload mixes are constructed using these applications and run in parallel.

TABLE IV
Characteristics of Applications Used in
This Study and the Number of
Frames of Each Application in the Workload

| | | | | Representation | |
|---|---|---|---|---|---|
| | # of | Execution | Supported | in workload | |
| App | Tasks | Time (μs) | Clusters | #frames | #tasks |
| WiFi-TX | 27 | 301 | big, LITTLE, FFT | 69 | 1863 |
| WiFi-RX | 34 | 71 | big. LITTLE, FFT, Viterbi | 111 | 3774 |
| RangeDet | 7 | 177 | big, LITTLE, FFT | 64 | 448 |
| SC-TX | 8 | 56 | big, LITTLE | 64 | 512 |
| SC-RX | 8 | 154 | big. LITTLE, Viterbi | 91 | 728 |
| TempMit | 10 | 81 | big. LITTLE, Matrix mult. | 101 | 1010 |
| TOTAL | | | | 500 | 8335 |

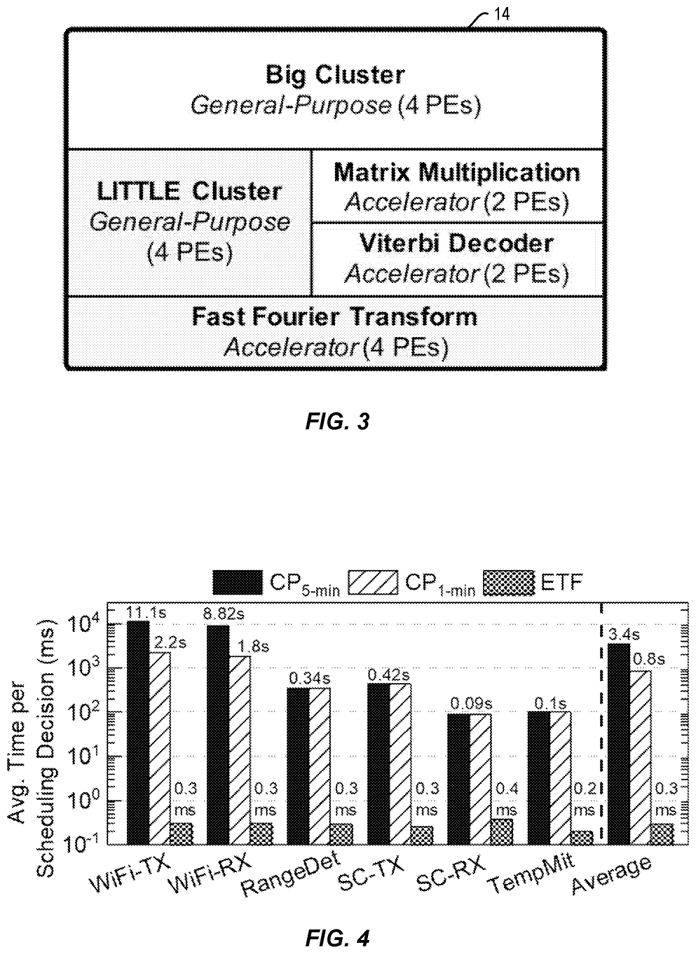

Heterogeneous SoC Configuration: FIG. 3 is a schematic diagram of an exemplary configuration of another heterogeneous many-core platform 14 used for scheduler evaluations. Considering the nature of applications, an SoC 18 (e.g., DSSoC) with sixteen PEs is employed, including accelerators for the most computationally intensive tasks; they are divided into five clusters with multiple homogeneous PEs, as illustrated in FIG. 3. To enable power-performance trade-off while using general-purpose cores, a big cluster with four Arm A57 cores and a LITTLE cluster with four Arm A53 cores is included. In addition, the SoC 18 integrates accelerator clusters for matrix multiplication, Fast Fourier Transform (FFT), and Viterbi decoder to address the computing requirements of the target domain applications summarized in Table IV. The accelerator interfaces are adapted from Joshua Mack, Nirmal Kumbhare, N. K. Anish, Umit Y. Ogras, and Ali Akoglu, “User-Space Emulation Framework For Domain-Specific SoC Design,” in 2020 IEEE International Parallel and Distributed Processing Symposium Workshops (IPDPSW), pp. 44-53, IEEE, 2020, the disclosure of which is incorporated herein by reference in its entirety. The number of accelerator instances in each cluster is selected based on how much the target applications use them. For example, three out of the six reference applications involve FFT, while range detection application alone has three FFT operations. Therefore, four instances of FFT hardware accelerators and two instances of Viterbi and matrix multiplication accelerators are employed, as shown in FIG. 3.

Simulation Framework: The proposed IL scheduler is evaluated using the discrete event-based simulation framework described in S. E. Arda et al., “DS3: A System-Level Domain-Specific System-on-Chip Simulation Framework,” in IEEE Transactions on Computers, vol. 69, no. 8, pp. 1248-1262, 2020 (referred to hereinafter as “DS3,” the disclosure of which is incorporated herein by reference in its entirety), which is validated against two commercial SoCs: Odroid-XU3 and Zynq Ultrascale+ ZCU102. This framework enables simulations of the target applications modeled as DAGs under different scheduling algorithms. More specifically, a new instance of a DAG arrives following a specified inter-arrival time rate and distribution, such as an exponential distribution. After the arrival of each DAG instance, called a frame, the simulator calls the scheduler under study. Then, the scheduler uses the information in the DAG and the current system state to assign the ready tasks to the waiting queues of the PEs. The simulator facilitates storing this information and the scheduling decision to construct the oracle, as described in Section III-B.

The execution times and power consumption for the tasks in the domain applications are profiled on Odroid-XU3 and Zynq ZCU102 SoCs. The simulator uses these profiling results to determine the execution time and power consumption of each task. After all the tasks that belong to the same frame are executed, the processing of the corresponding frame completes. The simulator keeps track of the execution time and energy consumed for each frame. These end-to-end values are within 3%, on average, of the measurements on Odroid-XU3 and Zynq ZCU102 SoCs.

Scheduling Algorithms Used for Oracle and Comparisons: A CP formulation is developed using IBM ILOG CPLEX Optimization Studio to obtain the optimal schedules whenever the problem size allows. After the arrival of each frame, the simulator calls the CP solver to find the schedule dynamically as a function of the current system state. Since the CP solver takes hours for large inputs (˜100 tasks), two versions are implemented with one minute (CP₁₋ₘᵢₙ) and five minutes (CP₅₋ₘᵢₙ) time-out per scheduling decision. When the model fails to find an optimal schedule, the best solution found within the time limit is used.

FIG. 4 is a graphical representation comparing average runtime per scheduling decision for various applications with CP₁₋ₘᵢₙ, CP₅₋ₘᵢₙ, and the ETF scheduler. This figure shows that the average time of the CP solver per scheduling decision for the benchmark applications is about 0.8 seconds and 3.5 seconds, respectively, based on the time limit. Consequently, one entire simulation can take up to 2 days, even with a time-out.

The ETF heuristic scheduler is also implemented, which goes over all tasks and possible assignments to find the earliest finish time considering communication overheads. Its average execution time is close to 0.3 ms, which is still prohibitive for a runtime scheduler, as shown in FIG. 4. However, it is observed that it performs better than CP₁₋ₘᵢₙ marginally worse than CP₅₋ₘᵢₙ, as detailed in Section IV-D.

Oracle generation with the CP formulation is not practical for two reasons. First, it is possible that for small input sizes (e.g., less than ten tasks), there might be multiple (incumbent) optimal solutions, and CP would choose one of them randomly. The other reason is that for large input sizes, CP terminates at the time limit providing the best solution found so far, which is sub-optimal. The sub-optimal solutions produced by CP vary based on the problem size and the limit. In contrast, ETF is easier to imitate at runtime and its results are within 8.2% of CP₅₋ₘᵢₙ results. Therefore, ETF is used as the oracle policy in the evaluations and the results of CP schedulers are used as reference points. IL policies for this oracle are trained in Section IV-B and their performance evaluated in Section IV-D.

B. Exploring Different Machine Learning Classifiers for IL

Various ML classifiers within the IL methodology are explored to approximate the oracle policy. One of the key metrics that drive the choice of ML techniques is the classification accuracy of the IL policies. At the same time, the policy should also have a low storage and execution time overheads. The following algorithms are evaluated for classification accuracy and implementation efficiency: regression tree (RT), support vector classifier (SVC), logistic regression (LR), and a multi-layer perceptron neural network (NN) with 4 hidden layers and 32 neurons in each hidden layer.

The classification accuracy of ML algorithms under study are listed in Table V. In general, all classifiers achieve a high accuracy to choose the cluster (the first column). At the second level, they choose the correct PE with high accuracy (>97%) within the hardware accelerator clusters. However, they have lower accuracy and larger variation for the LITTLE and big clusters. This is intuitive as the LITTLE and big clusters can execute all types of tasks in the applications, whereas accelerators execute fewer tasks. In strong contrast, a flat policy, which directly predicts the PE, results in training accuracy with 55% at best. Therefore, embodiments focus on the proposed hierarchical IL methodology.

TABLE V
Classification Accuracies of Trained IL Policies
with Different Machine Learning Classifiers

| | Cluster | LITTLE | big | MatMult | FFT | Viterbi |
|---|---|---|---|---|---|---|
| Classifier | Policy | Policy | Policy | Policy | Policy | Policy |
| RT | 99.6 | 93.8 | 95.1 | 99.9 | 99.5 | 100 |
| SVC | 95.0 | 85.4 | 89.9 | 97.8 | 97.5 | 98.0 |
| LR | 89.9 | 79.1 | 72.0 | 98.7 | 98.2 | 98.0 |
| NN | 97.7 | 93.3 | 93.6 | 99.3 | 98.9 | 98.1 |

Regression trees (RTs) trained with a maximum depth of 12 produce the best accuracy for the cluster and PE policies, with more than 99.5% accuracy for the cluster and hardware acceleration policies. RT also produces an accuracy of 93.8% and 95.1% to predict PEs within the LITTLE and big clusters, respectively, which is the highest among all the evaluated classifiers. The classification accuracy of NN policies is comparable to RT, with a slightly lower cluster prediction accuracy of 97.7%. In contrast, SVC and LR are not preferred due to lower accuracy of less than 90% and 80%, respectively, to predict PEs within LITTLE and big clusters.

RTs and NNs are chosen to analyze the latency and storage overheads (due to their superior performance). The latency of RT is 1.1 μs on Arm Cortex-A15 in Odroid-XU3 and on Arm Cortex-A53 in Zynq ZCU102, as shown Table VI. In comparison, the scheduling overhead of CFS, the default Linux scheduler, on Zynq ZCU102 running Linux Kernel 4.9 is 1.2 μs, which is slightly larger than the solution presented herein. The storage overhead of an RT policy is 19.33 KB. The NN policies incur an overhead of 14.4 μs on the Arm Cortex-A15 cluster in Odroid-XU3 and 37 μs on Arm Cortex-A53 in Zynq, with a storage overhead of 16.89 KB. NNs are preferable for use in an online environment as their weights can be incrementally updated using the back-propagation algorithm. However, due to competitive classification accuracy and lower latency overheads of RTs over NNs, RT is chosen for the rest of the evaluations.

TABLE VI
Execution Time and Storage Overheads per IL Policy
for Regression Tree and Neural Network Classifiers

| | Latency (μs) | | |
|---|---|---|---|
| | Odroid-XU3 | Zynq Ultrascale+ | Storage |
| Classifier | (Arm A15) | ZCU102 (Arm A53) | (KB) |
| RT | 1.1 | 1.1 | 19.3 |
| NN | 14.4 | 37 | 16.9 |

C. Feature Space Exploration with Regression Tree Classifier

This section explores the significance of the features chosen to represent the state. For this analysis, the impact of the input features on the training accuracy is assessed with RT classifier and average execution time following a systematic approach.

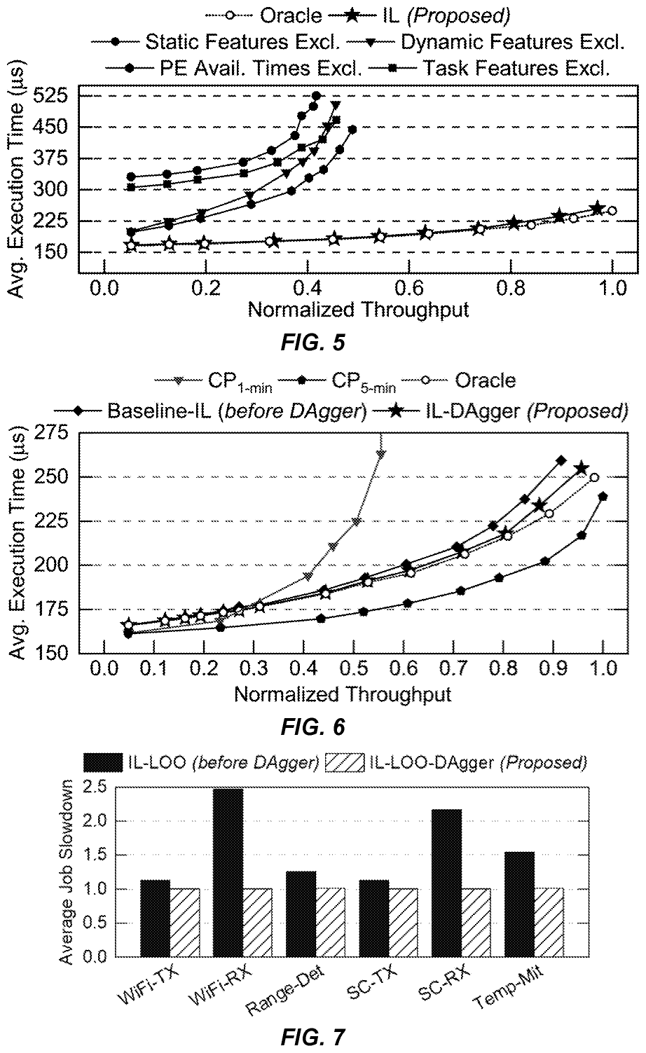

FIG. 5 is a graphical representation comparing average execution time of the applications for various applications with oracle, IL (proposed), and IL policies with subsets of features. The training accuracy with subsets of features and the corresponding scheduler performance are shown in Table VII and FIG. 5, respectively. First, all static features are excluded from the training dataset. The training accuracy for the prediction of the cluster significantly drops by 10%. Since hierarchical IL policies are used, an incorrect first-level decision results in a significant penalty for the decisions at the next level. Second, all dynamic features are excluded from training. This results in a similar impact for the cluster policy (10%) but significantly affects the policies constructed for the LITTLE, big, and FFT. Next, a similar trend is observed when PE availability times are excluded from the feature set. The accuracy is marginally higher since the other dynamic features contribute to learning the scheduling decisions. Finally, a few task related features are removed, such as the downward depth, task, and application identifier. In this case, the impact is to the cluster policy accuracy since these features describe the node in the DAG and influence the cluster mapping.

TABLE VII
Training Accuracy of IL Policies with
Subsets of the Proposed Feature Set

| Features | | | | | | |
|---|---|---|---|---|---|---|
| Excluded from | Cluster | LITTLE | big | MatMul | FFT | Viterbi |
| Training | Policy | Policy | Policy | Policy | Policy | Policy |
| None | 99.6 | 93.8 | 95.1 | 99.9 | 99.5 | 100 |
| Static | 87.3 | 93.8 | 92.7 | 99.9 | 99.5 | 100 |
| features | | | | | | |
| Dynamic | 88.7 | 52.1 | 57.6 | 94.2 | 70.5 | 98 |
| features | | | | | | |
| PE availability | 92.2 | 51.1 | 61.5 | 94.1 | 66.7 | 98.1 |
| times | | | | | | |
| Task ID, depth, | 90.9 | 93.6 | 95.3 | 99.9 | 99.5 | 100 |
| app. ID | | | | | | |

As observed in FIG. 5, the average execution time of the workload significantly degrades when all features are not included. Hence, the chosen features help to construct effective IL policies, approximating the Oracle with over 99% accuracy in execution time.

D. IL-Scheduler Performance Evaluation

This section compares the performance of the proposed policy to the ETF Oracle, CP₁₋ₘᵢₙ, and CP₅₋ₘᵢₙ. Since heterogeneous many-core systems are capable of running multiple applications simultaneously, the frames in the application mix (see Table IV) are streamed with increasing injection rates. For example, a normalized throughput of 1.0 in FIG. 6 corresponds to 19.78 frames/ms. Since the frames are injected faster than they can be processed, there are many overlapping frames at any given time.

First, the IL policies are trained with all six reference applications, which is referred to as the baseline-IL scheduler. IL policies suffer from error propagation due to the non i.i.d. nature of training data. To overcome this limitation, a data aggregation technique adapted for a hierarchical IL framework (IL-DAgger) is used, as discussed in Section III-C. A DAgger iteration involves executing the entire workload. Ten DAgger iterations are executed and the best iteration with performance within 2% of the Oracle is chosen. If the target is not achieved, more iterations are performed.

FIG. 6 is a graphical representation comparing average job execution time between Oracle, CP solutions, and IL policies to schedule a workload comprising a mix of six streaming applications. FIG. 6 shows that the proposed IL-DAgger scheduler performs almost identical to the Oracle; the mean average percentage difference between them is 1%. More notably, the gap between the proposed IL-DAgger policy and the optimal CP₅₋ₘᵢₙ solution is only 9.22%. CP₅₋ₘᵢₙ is included only as a reference point, but it has six orders of magnitude larger execution time overhead and cannot be used at runtime. Furthermore, the proposed approach performs better than CP₁₋ₘᵢₙ, which is not able to find a good schedule within the one-minute time limit per decision. Finally, the baseline IL can approach the performance of the proposed policy. This is intuitive since both policies are tested on known applications in this evaluation. This is in contrast to the leave one out embodiments presented in Section IV-E.

Pulse Doppler Application Case Study: The applicability of the proposed IL-scheduling technique is demonstrated in complex scenarios using a pulse Doppler application. It is a real-world radar application, which computes the velocity of a moving target object. This application is significantly more complex, with 13-64 more tasks than the other applications. Specifically, it consists of 449 tasks comprising 192 FFT tasks, 128 inverse-FFT tasks, and 129 other computations. The FFT and inverse-FFT operations can execute on the general-purpose cores and hardware accelerators. In contrast, the other tasks can execute only on the general-purpose cores.

The proposed IL policies achieve an average execution time within 2% of the Oracle. The 2% error is acceptable, considering that the application saturates the computing platform quickly due to its high complexity. Moreover, the CP-based approach does not produce a viable solution either with 1-minute or 5-minute time limits due to the large problem size. For this reason, this application is not included in workload mixes and the rest of the comparisons.

E. Illustration of Generalization with IL for Unseen Applications, Runtime Variations and Platforms

This section analyzes the generalization of the proposed IL-based scheduling approach to unseen applications, runtime variations, and many-core platform configurations.

IL-Scheduler Generalization to Unseen Applications using Leave-one-out Embodiments: IL, being an adaptation of supervised learning for sequential decision making, suffers from lack of generalization to unseen applications. To analyze the effects of unseen applications, IL policies are trained, excluding applications one each at a time from the training dataset.

To compare the performances of two schedulers S₁ and S₂, the job slowdown metric slowdown_{S}_{₁}_{,S}_{₂}=T_{S}_{₁}/T_{S}_{₂} is used. slowdown_{S}_{₁}_{,S}_{₂}>1 when T_{S}_{₁}>T_{S}_{₂}. The average slowdown of scheduler S₁ with respect to scheduler S₂ is computed as the average slowdown for all jobs at all injection rates. The results present an interesting and intuitive explanation of the average job slowdown in execution times for each of the leave-one-out embodiments.

FIG. 7 is a graphical representation comparing average slowdown of a baseline IL leave-one-out (IL-LOO) and proposed policy with DAgger leave-one-out (IL-LOO-DAgger) iterations with respect to the Oracle. The proposed policy outperforms the baseline IL for all applications, with the most significant gains obtained for WiFi-RX and SC-RX applications. These two applications consist of a Viterbi decoder operation, which is very expensive to compute on general-purpose cores and highly efficient to compute on hardware accelerators. When these applications are excluded, the IL policies are not exposed to the corresponding states in the training dataset and make incorrect decisions. The erroneous PE assignments lead to an average slowdown of more than 2× for the receiver applications. The slowdown when the transmitter applications (WiFi-TX and SCTX) are excluded from training is approximately 1.13×. Range detection and temporal mitigation applications experience a slowdown of 1.25× and 1.54×, respectively, for leave-one-out embodiments. The extent of the slowdown in each scenario depends on the application excluded from training and its execution time profile in the different processing clusters. In summary, the average slowdown of all leave-one-out IL policies after DAgger (IL-LOO-DAgger) improves to ˜1.01× in comparison with the Oracle, as shown in FIG. 7.

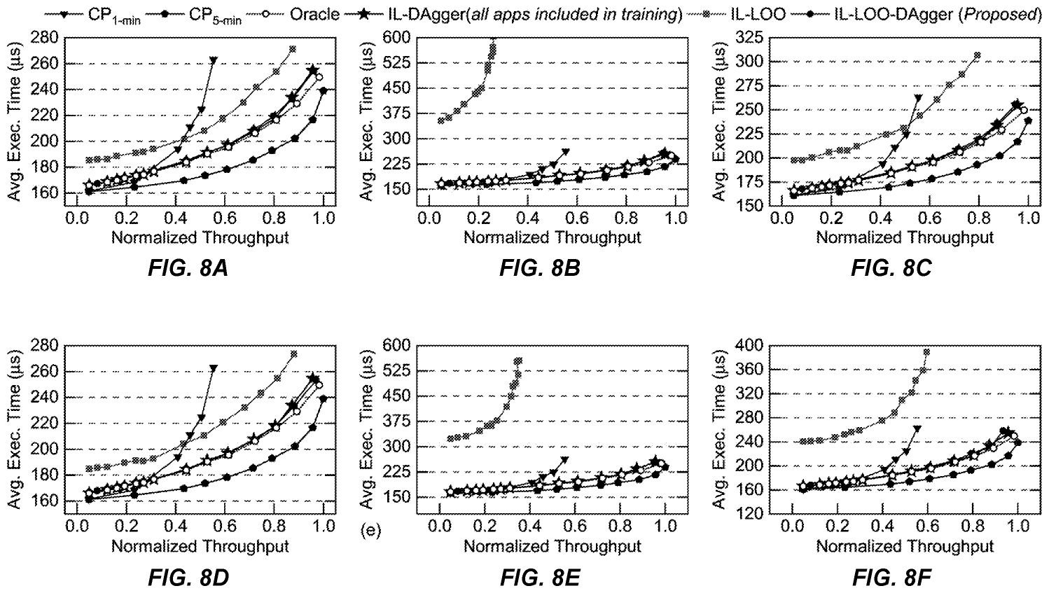

FIG. 8A is a graphical representation of average job execution times for the Oracle, baseline-IL, as well as IL-LOO and IL-LOO-DAgger iterations with the WiFi-TX application left out. FIG. 8B is a graphical representation of average job execution times for the Oracle, baseline-IL, as well as IL-LOO and IL-LOO-DAgger iterations with the WiFi-RX application left out. FIG. 8C is a graphical representation of average job execution times for the Oracle, baseline-IL, as well as IL-LOO and IL-LOO-DAgger iterations with the RangeDet application left out. FIG. 8D is a graphical representation of average job execution times for the Oracle, baseline-IL, as well as IL-LOO and IL-LOO-DAgger iterations with the SC-TX application left out. FIG. 8E is a graphical representation of average job execution times for the Oracle, baseline-IL, as well as IL-LOO and IL-LOO-DAgger iterations with the SC-RX application left out. FIG. 8F is a graphical representation of average job execution times for the Oracle, baseline-IL, as well as IL-LOO and IL-LOO-DAgger iterations with the TempMit application left out.

The highest number of DAgger iterations needed was 8 for the SC-RX application, and the lowest was 2 for the range detection application. If the DAgger criterion is relaxed to achieving a slowdown of 1.02×, all applications achieve the same in less than 5 iterations. A drastic improvement in the accuracy of the IL policies with few iterations shows that the policies generalize quickly and well to unseen applications, thus making them suitable for applicability at runtime.

IL-Scheduler Generalization with Runtime Variations: Tasks experience runtime variations due to variations in system workload, memory, and congestion. Hence, it is crucial to analyze the performance of the proposed approach when tasks experience such variations, rather than observing only their static profiles. The simulator accounts for variations by using a Gaussian distribution to generate variations in execution time. To allow evaluation in a realistic scenario, all tasks in every application are profiled on big and LITTLE cores of Odroid-XU3, and, on Cortex-A53 cores and hardware accelerators on Zynq for variations in execution time.

The average standard deviation is presented as a ratio of execution time for the tasks in Table VIII. The maximum standard deviation is less than 2% of the execution time for the Zynq platform, and less than 8% on the Odroid-XU3. To account for variations in runtime, a noise of 1%, 5%, 10%, and 15% is added in task execution time during simulation. The IL policies achieve average slowdowns of less than 1.01× in all cases of runtime variations. Although IL policies are trained with static execution time profiles, the aforementioned results demonstrate that the IL policies adapt well to execution time variations at runtime. Similarly, the policies also generalize to variations in communication time and power consumption.

TABLE VIII
Standard Deviation (in Percentage of Execution Time) Profiling
of Applications in Odroid-XU3 and Zynq ZCU-102

| | WiFi- | WiFi- | | SC- | SC- | |
|---|---|---|---|---|---|---|
| Application | TX | RX | RangeDet | TX | RX | TempMit |
| Zynq ZCU-102 | 0.34 | 0.56 | 0.66 | 1.15 | 1.80 | 0.63 |
| Odroid-XU3 | 6.43 | 5.04 | 5.43 | 6.76 | 7.14 | 3.14 |

IL-Scheduler Generalization with Platform Configuration: This section presents a detailed analysis of the IL policies by varying the configuration i.e., the number of clusters, general-purpose cores, and hardware accelerators. To this end, five different SoC configurations are chosen as presented in Table IX. The Oracle policy for a configuration G1 is denoted by π^{*G1}. An IL policy evaluated on configuration G1 is denoted as π^{G1}. G1 is the baseline configuration that is used for extensive evaluation. Between configurations G1-G4, the number of PEs within each cluster are varied. A degenerate case is also considered that comprises only LITTLE and big clusters (configuration G5). IL policies are trained with only configuration G1. The average execution times of π^{G1}, π^{G2}, and π^{G3} are within 1%, π^{G4} performs within 2%, and π^{G5} performs within 3%, of their respective Oracles.

TABLE IX
Configuration of Many-Core Platforms

| Platform | LITTLE | big | MatMul | FFT | Decoder |
|---|---|---|---|---|---|
| Config. | PEs | PEs | Acc. PEs | Acc. PEs | Acc, PEs |
| G1 (Baseline) | 4 | 4 | 2 | 4 | 2 |
| G2 | 2 | 2 | 2 | 2 | 2 |
| G3 | 1 | 1 | 1 | 1 | 1 |
| G4 | 4 | 4 | 1 | 1 | 1 |
| G5 | 4 | 4 | 0 | 0 | 0 |

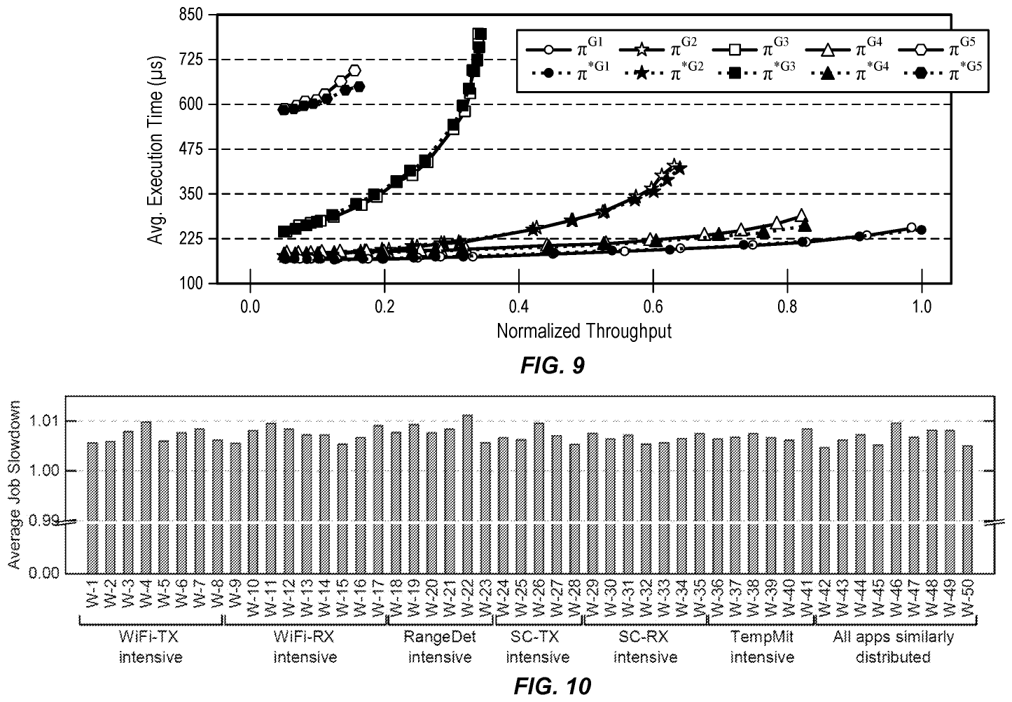

FIG. 9 is a graphical representation of the IL policy evaluation with various many-core platform configurations. The accuracy of π^{G5} with respect to the corresponding Oracle (π^{G5}) is slightly lower (97%) as the platform saturates the computing resources very quickly, as shown in FIG. 9. Based on these evaluations, the IL policies generalize well for the different many-core platform configurations. The change in system configuration is accurately captured in the features (in execution times, PE availability times, etc.), which enables good generalization to new platform configurations. When the cluster configuration in the many-core platform changes, the IL policies generalize well (within 3%) but can also be improved by using Dagger to obtain improved performance (within 1% of the Oracle).

F. Performance Analysis with Multiple Workloads

To demonstrate the generalization capability of the IL policies trained and aggregated on one workload (IL-DAgger), the performance of the same policies is evaluated on 50 different workloads consisting of different combinations of application mixes at varying injection rates, and each of these workloads contains 500 frames. For this extensive evaluation, workloads are considered, each of which are intensive on one of WiFi-TX, WiFi-RX, range detection, SC-TX, SC-RX, and temporal mitigation. Finally, workloads are also considered in which all applications are distributed similarly.

FIG. 10 is a graphical representation comparing the average slowdown for each of the 50 different workloads (represented as W-1, W-2, and so on) normalized to IL-DAgger policies against the Oracle. While W-22 observes a slowdown of 1.01× against the Oracle, all other workloads experience an average slowdown of less than 1.01× (within 1% of Oracle). Independent of the distribution of the applications in the workloads, the IL policies approximate the Oracle well. On average, the slowdown is less than 1.01×, demonstrating the IL policies generalize to different workloads and streaming intensities.

G. Evaluation with Energy and Energy-Delay Objectives

Average execution time is crucial in configuring computing systems for meeting application latency requirements and user experience. Another critical metric in modern computing systems, especially battery-powered platforms, is energy consumption. Hence, this section presents the proposed IL-based approach with the following objectives: performance, energy, energy-delay product (EDP), and energy-delay² product (ED²P). ETF is adapted to generate Oracles for each objective. Then, the different Oracles are used to train IL policies for the corresponding objectives. The scheduling decisions are significantly more complex for these Oracles. Hence, an RT of depth 16 (execution time uses RT of depth 12) is used to learn the decisions accurately. The average latency per scheduling decision remains similar for RT of depth 16 (˜1.1 μs) on Cortex-A53.

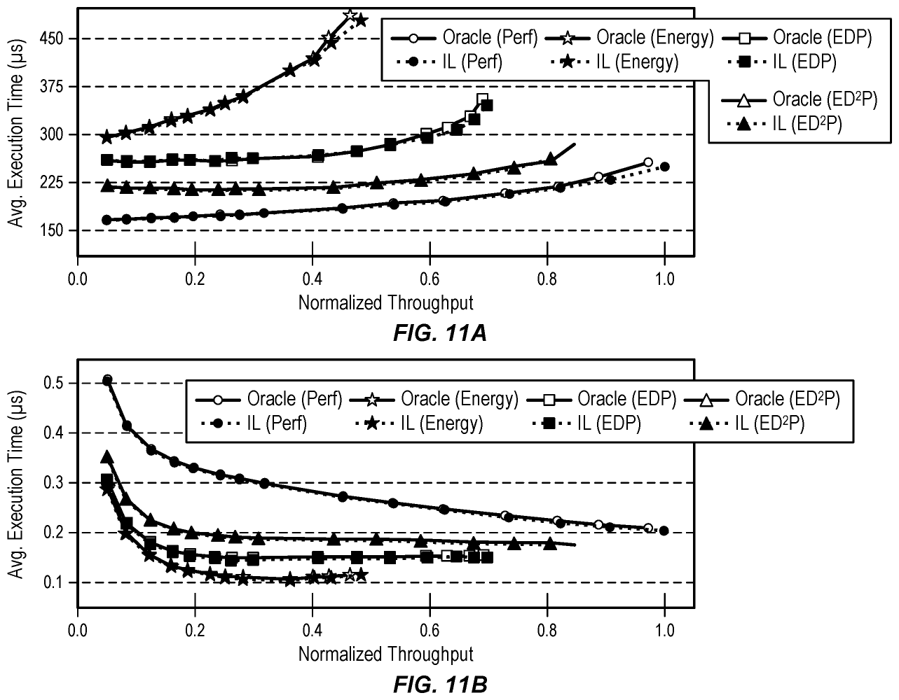

FIG. 11A is a graphical representation of average execution time of the workload with Oracles and IL policies for performance, EDP, and ED²P objectives. FIG. 11B is a graphical representation of average energy consumption of the workload with Oracles and IL policies for performance, EDP, and ED²P objectives. The lowest energy is achieved by the energy Oracle, while it increases as more emphasis is added to performance (EDP→ED²P→performance), as expected. The average execution time and energy consumption in all cases are within 1% of the corresponding Oracles. This demonstrates the proposed IL scheduling approach is powerful as it learns from Oracles that optimize for any objective.

H. Comparison with Reinforcement Learning

Since the state-of-the-art machine learning techniques do not target streaming DAG scheduling in heterogeneous many-core platforms, a policy-gradient based reinforcement learning technique is implemented using a deep neural network (multi-layer perceptron with 4 hidden layers with 32 neurons in each hidden layer) to compare with the proposed IL-based task scheduling technique. For the RL implementation, the exploration rate is varied between 0.01 to 0.99 and learning rate from 0.001 to 0.01. The reward function is adapted from H. Mao, M. Schwarzkopf, S. B. Venkatakrishnan, Z. Meng, and M. Alizadeh, “Learning Scheduling Algorithms for Data Processing Clusters,” in ACM Special Interest Group on Data Communication, 2019, pp. 270-288. RL starts with random weights and then updates them based on the extent of exploration, exploitation, learning rate, and reward function. These factors affect convergence and quality of the learned RL models.

Fewer than 20% of the evaluations with RL converge to a stable policy and less than 10% of them provide competitive performance compared to the proposed IL-scheduler. The RL solution that performs best is chosen to compare with the IL-scheduler. The Oracle generation and training parts of the proposed technique take 5.6 minutes and 4.5 minutes, respectively, when running on an Intel Xeon E5-2680 processor at 2.40 GHz. In contrast, an RL-based scheduling policy that uses the policy gradient method converges in 300 minutes on the same machine. Hence, the proposed technique is 30× faster than RL.

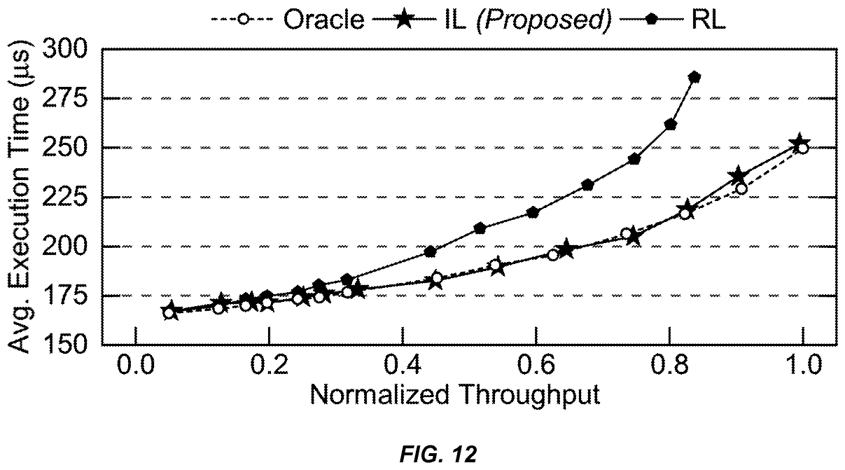

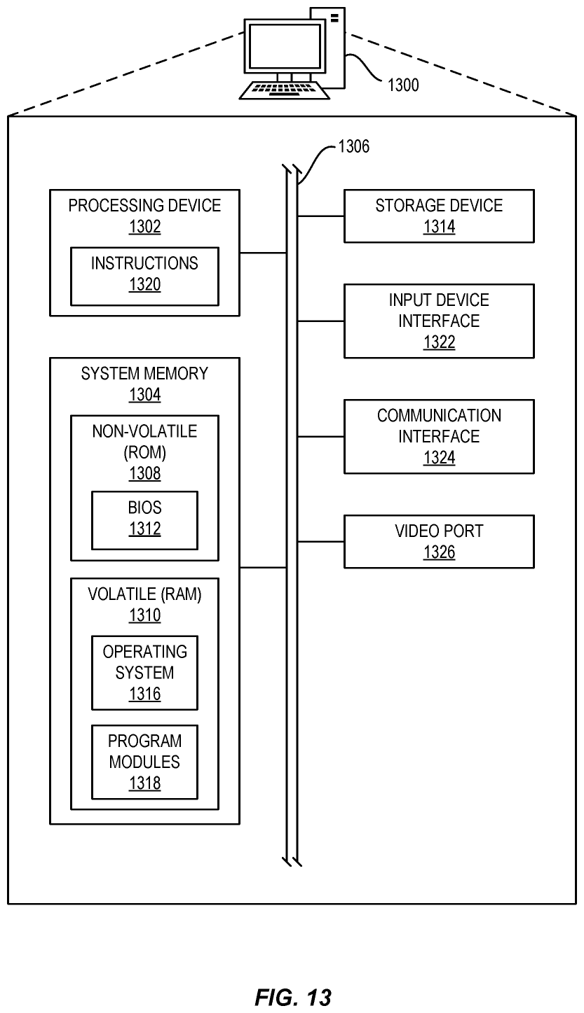

FIG. 12 is a graphical representation comparing average execution time between Oracle, IL, and RL policies to schedule a workload comprising a mix of six streaming real-world applications. As shown in FIG. 12, the RL scheduler performs within 11% of the Oracle, whereas the IL scheduler presents average execution time that is within 1% of the Oracle.

In general, RL-based schedulers suffer from the following drawbacks: (1) need for excessive fine-tuning of the parameters (learning rate, exploration rate, and NN structure), (2) reward function design, and (3) slow convergence for complex problems. In strong contrast, IL policies are guided by strong supervision eliminating the slow convergence problem and the need for a reward function.

I. Complexity Analysis of the Proposed Approach

This section compares the complexity of the proposed IL-based task scheduling approach with ETF, which is used to construct the Oracle policies. The complexity of ETF is O(n²m), where n is the number of tasks and m is the number of PEs in the system. While ETF is suitable for use in Oracle generation (offline), it is not efficient for online use due to the quadratic complexity on the number of tasks. However, the proposed IL-policy which uses regression tree has the complexity of O(n). Since the complexity of the proposed IL-based policies is linear, it is practical to implement in heterogeneous many-core systems.

V. Computer System

FIG. 13 is a block diagram of a computer system 1300 suitable for implementing runtime task scheduling with IL according to embodiments disclosed herein. Embodiments described herein can include or be implemented as the computer system 1300, which comprises any computing or electronic device capable of including firmware, hardware, and/or executing software instructions that could be used to perform any of the methods or functions described above. In this regard, the computer system 1300 may be a circuit or circuits included in an electronic board card, such as a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computer system 1300 in this embodiment includes a processing device 1302 or processor, a system memory 1304, and a system bus 1306. The system memory 1304 may include non-volatile memory 1308 and volatile memory 1310. The non-volatile memory 1308 may include read-only memory (ROM), erasable programmable read-only memory (EPROM), electrically erasable programmable read-only memory (EEPROM), and the like. The volatile memory 1310 generally includes random-access memory (RAM) (e.g., dynamic random-access memory (DRAM), such as synchronous DRAM (SDRAM)). A basic input/output system (BIOS) 1312 may be stored in the non-volatile memory 1308 and can include the basic routines that help to transfer information between elements within the computer system 1300.

The system bus 1306 provides an interface for system components including, but not limited to, the system memory 1304 and the processing device 1302. The system bus 1306 may be any of several types of bus structures that may further interconnect to a memory bus (with or without a memory controller), a peripheral bus, and/or a local bus using any of a variety of commercially available bus architectures.

The processing device 1302 represents one or more commercially available or proprietary general-purpose processing devices, such as a microprocessor, central processing unit (CPU), or the like. More particularly, the processing device 1302 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 1302 is configured to execute processing logic instructions for performing the operations and steps discussed herein.

In this regard, the various illustrative logical blocks, modules, and circuits described in connection with the embodiments disclosed herein may be implemented or performed with the processing device 1302, which may be a microprocessor, field programmable gate array (FPGA), a digital signal processor (DSP), an application-specific integrated circuit (ASIC), or other programmable logic device, a discrete gate or transistor logic, discrete hardware components, or any combination thereof designed to perform the functions described herein. Furthermore, the processing device 1302 may be a microprocessor, or may be any conventional processor, controller, microcontroller, or state machine. The processing device 1302 may also be implemented as a combination of computing devices (e.g., a combination of a DSP and a microprocessor, a plurality of microprocessors, one or more microprocessors in conjunction with a DSP core, or any other such configuration).

The computer system 1300 may further include or be coupled to a non-transitory computer-readable storage medium, such as a storage device 1314, which may represent an internal or external hard disk drive (HDD), flash memory, or the like. The storage device 1314 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as optical disks, magnetic cassettes, flash memory cards, cartridges, and the like, may also be used in the operating environment, and, further, that any such media may contain computer-executable instructions for performing novel methods of the disclosed embodiments.

An operating system 1316 and any number of program modules 1318 or other applications can be stored in the volatile memory 1310, wherein the program modules 1318 represent a wide array of computer-executable instructions corresponding to programs, applications, functions, and the like that may implement the functionality described herein in whole or in part, such as through instructions 1320 on the processing device 1302. The program modules 1318 may also reside on the storage mechanism provided by the storage device 1314. As such, all or a portion of the functionality described herein may be implemented as a computer program product stored on a transitory or non-transitory computer-usable or computer-readable storage medium, such as the storage device 1314, volatile memory 1310, non-volatile memory 1308, instructions 1320, and the like. The computer program product includes complex programming instructions, such as complex computer-readable program code, to cause the processing device 1302 to carry out the steps necessary to implement the functions described herein.

An operator, such as the user, may also be able to enter one or more configuration commands to the computer system 1300 through a keyboard, a pointing device such as a mouse, or a touch-sensitive surface, such as the display device, via an input device interface 1322 or remotely through a web interface, terminal program, or the like via a communication interface 1324. The communication interface 1324 may be wired or wireless and facilitate communications with any number of devices via a communications network in a direct or indirect fashion. An output device, such as a display device, can be coupled to the system bus 1306 and driven by a video port 1326. Additional inputs and outputs to the computer system 1300 may be provided through the system bus 1306 as appropriate to implement embodiments described herein.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

Those skilled in the art will recognize improvements and modifications to the preferred embodiments of the present disclosure. All such improvements and modifications are considered within the scope of the concepts disclosed herein and the claims that follow.

What is claimed is:

1. A method for runtime task scheduling in a heterogeneous multi-core computing system, the method comprising:
obtaining an application comprising a plurality of tasks;
obtaining imitation learning (IL) policies for task scheduling; and
scheduling the plurality of tasks on a heterogeneous set of processing elements according to the IL policies.

2. The method of claim 1, wherein obtaining the IL policies comprises training the IL policies offline.

3. The method of claim 2, wherein training the IL policies offline uses supervised machine learning.

4. The method of claim 3, wherein the supervised machine learning comprises one or more of a linear regression, a regression tree, or a neural network.

5. The method of claim 3, wherein obtaining the IL policies further comprises:
constructing an oracle; and
training the IL policies using the oracle.

6. The method of claim 5, wherein obtaining the IL policies further comprises generating training data for the IL policies using a simulation of the heterogeneous multi-core computing system.

7. The method of claim 6, wherein obtaining the IL policies further comprises improving the IL policies based on aggregated data from oracle actions and results of the IL policies during simulation.

8. The method of claim 7, wherein improving the IL policies comprises:
labeling a current oracle action for a task when IL policy actions are different from the oracle actions;
retraining the IL policies using the aggregated data comprising the labeled oracle action and a corresponding system state.

9. The method of claim 5, wherein the oracle is constructed from samples of multiple scheduling algorithms.

10. The method of claim 1, further comprising scheduling application tasks for multi-tasking across a plurality of applications on the heterogeneous set of processing elements according to the IL policies.

11. An application scheduling framework, comprising:
a heterogeneous system-on-chip (SoC) simulator configured to simulate a plurality of scheduling algorithms for a plurality of application tasks; and
an oracle configured to predict actions for task scheduling during runtime; and
an imitation learning (IL) policy generator configured to generate IL policies for task scheduling during runtime on a heterogeneous SoC, wherein the IL policies are trained using the oracle and the SoC simulator.

12. The application scheduling framework of claim 11, wherein the IL policy generator is configured to generate the IL policies based on supervised machine learning with the oracle such that the IL policies imitate the oracle for scheduling tasks at runtime of the heterogeneous SoC.

13. The application scheduling framework of claim 12, further comprising a data aggregator (DAgger) configured to improve the IL policies based on oracle actions and results of the IL policies during simulation.

14. The application scheduling framework of claim 13, wherein the DAgger is configured to aggregate a current system state and label a current oracle action for a task when IL policy actions are different from the oracle actions.

15. The application scheduling framework of claim 13, wherein the DAgger is further configured to improve the IL policies based on results of the IL policies during runtime on the heterogeneous SoC.

16. The application scheduling framework of claim 11, wherein the SoC simulator is based on a heterogeneous SoC having heterogeneous processing elements grouped into different types of processing clusters.

17. The application scheduling framework of claim 16, wherein the IL policies are hierarchical, and a first-level IL policy predicts one of the processing clusters to be scheduled for each of the plurality of application tasks.

18. The application scheduling framework of claim 17, wherein a second-level IL policy predicts a processing element within the one predicted processing cluster to be scheduled for each of the plurality of application tasks.

19. The application scheduling framework of claim 18, wherein the heterogeneous SoC comprises one or more general processor clusters and one or more hardware accelerator clusters.

20. The application scheduling framework of claim 19, wherein the one or more hardware accelerator clusters comprises at least one of: a cluster of matrix multipliers, a cluster of Viterbi decoders, a cluster of fast Fourier transform (FFT) accelerators, a cluster of graphical processing units (GPUs), a cluster of digital signal processors (DSPs), or a cluster of tensor processing units (TPUs).
